(19) United States
(12) Patent Application Publication
(10) Pub. No.: US 2005/0159270 A1
(43) Pub. Date: Jul. 21, 2005

(54) Arrangement and method for allowing disengagement of a gear in a gearbox

(76) Inventor: Lars-Gunnar Hedstrom, Vagnharad (SE)

Correspondence Address: OSTROLENK FABER GERB & SOFFEN, 1180 AVENUE OF THE AMERICAS, NEW YORK, NY, 100368403, US

(21) Appl. No.: 10/505,382

(22) PCT Filed: Mar. 17, 2003
(86) PCT No.: PCT/SE03/00440

(30) Foreign Application Priority Data
Mar. 19, 2002 (SE) 0200829-0

(51) Int. Cl. B60K 41/02

(52) U.S. Cl. 477/70

(57) ABSTRACT

An arrangement and a method for allowing disengagement of a gear of a gearbox in a vehicle. A clutch provides elastic rotation when driving torque is transmitted in the driveline. A first sensor detects the position (P1) of a first component of a driveline which is situated before the clutch and a second sensor detects the position (P2) of a second component of the driveline which is situated after the clutch. A control unit stores at least one measured value which is related to a mutual angle (AREF) between the first component and the second component when a gear is engaged in the gearbox, and initiates an engine control action such that the mutual angle (AREF) between the first component and the second component is rectified before the gear is disengaged.

### BACKGROUND TO THE INVENTION, AND STATE OF THE ART

The invention relates to an arrangement and a method for allowing disengagement of a gear in a gearbox according to the preambles of claims 1 and 11.

When disengaging a gear in a gearbox in a vehicle without using a clutch, it is important that a torque-free state prevails at the gearwheel contact point of the gear engaged, otherwise the disengagement of a gear results in bad gearchange comfort and longer gearchange time. Disengaging a gear at a time when torque is being transmitted at the gearwheel contact point also initiates a comfort-disturbing oscillation in the driveline. The torque-free state in the gearbox is hereinafter referred to as zero torque. Zero torque at the gearwheel contact point occurs when the engine delivers a torque which balances the mass moment of inertia in the driveline. To achieve zero torque, the torque delivered by the engine must also balance any randomly occurring torque. Such randomly occurring torque arises in connection with power takeoff from the engine to auxiliary units such as air-conditioning systems, compressors etc. Other factors such as hydraulic instability in the engine's injection equipment, oscillations in the driveline etc. also make it difficult to determine the requisite engine torque.

SE 502 807 refers to a method for controlling an engine's torque with the object of achieving a zero torque level in a gearbox at the time of disengagement of a gear. In that case the engine torque required of the specific engine for there to be zero torque in the gearbox is calculated, following by the engine being supplied with the quantity of fuel needed for providing the calculated engine torque.

SE 504 717 refers to a further development of the method described above. It involves not only calculation of the engine torque required for achieving zero torque in the gearbox but also a measurement at each individual gearchange process to assess whether the calculated engine torque delivered at the time of disengaging a gear was correct. If such was not the case, a correction to the calculated torque is applied at the next gearchange by applying a value which corresponds to the error at the previous gear disengagement.

SE 507 436 further refers to a method for enabling correction of a calculated engine torque delivered. In this case the speed of the gearbox output shaft is measured. If the shaft exhibits a speed change immediately after a gear has been disengaged, it may be found that zero torque did not prevail in the gearbox when the gear was disengaged. In such cases, the calculated engine torque is subjected, at a subsequent gear change, to correction by applying a value which is related to the amplitude of the gearbox output shaft speed change.

SE 507 869 refers to a method for control of engine torque when a vehicle is changing gear. In this case the torsional rotation of the vehicle's driveshafts is taken as a measure of the prevailing driving torque in the gearbox. A prevailing torsional rotation value is determined by processing of signals representing current measurements of engine speed and the speed of the powered wheels. The engine's torque is then adjusted until the torsional rotation is nil, whereupon disengagement of the engaged gear is effected.

The above known methods are functional but require advanced calculations involving a number of parameters if the engine torque which corresponds to zero torque in the gearbox is to be determined. However, it is difficult to determine the required engine torque, since the latter may vary with the power takeoff requirements of various auxiliary units and other factors such as oscillations in the driveline. Moreover, supplying fuel in a quantity such that an engine exactly achieves a calculated engine torque is complicated, inter alia because the quality of the fuel may vary. The known methods are also relatively time-consuming and it would be desirable to be able to reduce the time taken to control the engine torque and detect zero torque in the gearbox so that the engaged gear can be disengaged.

### SUMMARY OF THE INVENTION

The object of the present invention is to provide a method and arrangement which simply and reliably result in substantially zero torque in a gearbox so as to allow disengagement of a gear without using a clutch.

This object is achieved with the arrangement and method mentioned in the introduction which are characterised by what is said in the characterising parts of claims 1 and 11. All the components which form part of a driveline result in a certain elastic rotation with a value which is related to the driving torque transmitted. When a driving torque is transmitted in the driveline, the driveline components situated before the specific component and those situated after the specific component thus have a mutual elastic rotation relative to one another. If a positive driving torque is transmitted the result is a mutual rotation in one direction, and if a negative driving torque is transmitted the result is a mutual rotation in the opposite direction. When zero torque prevails in the gearbox, there will thus be no mutual rotation between the components of the driveline. When a gear is engaged in the gearbox, zero torque prevails at the gearwheel contact point in the gearbox. Measurement of reference values pertaining to the position of the first component and the position of the second component when a gear is engaged in the gearbox provides information about the mutual angle between said components when zero torque prevails. A driver thereafter wishing to engage a new gear in the gearbox sets in motion an endeavour to rectify this mutual angle of the components so that engagement of the new gear can be effected at zero torque in the gearbox. To this end, the control unit initiates appropriate control of the engine so as to rectify the mutual angle of the first and second components. The control unit preferably receives substantially continuously parameter values pertaining to the respective prevailing positions of the first and second components. When the parameter value which corresponds to the mutual angle of the components is received, it may be found that zero torque prevails in the gearbox and said gear can be engaged.

According to an embodiment of the present invention, said specific component is incorporated in a clutch. Conventional clutches are often of a design which results in a relatively large elastic rotation relative to the driving torque transmitted. To avoid setting too high requirements for accuracy of measurement of the positions of the components, it is advantageous that said specific component provide a relatively large rotation relative to the driving torque transmitted. With advantage, said specific component is a clutch disc which allows elastic rotation between a hub and a peripheral portion. In many cases, clutch discs incorporate a resilient fastening between the hub and the peripheral portion. The resilient fastening results in a non-linear relationship between the magnitude of the rotation and the driving torque transmitted so that there is a relatively large rotation between the hub and the peripheral portion even when the driving torque is relatively low. This means that in such cases there is no particularly high requirement for measurement accuracy of the sensors. If the angle of rotation in this case is not exactly 0°, the driving torque transmitted will nevertheless be low enough to allow the engaged gear to be disengaged in an acceptable manner. The magnitude of the rotation relative to the driving torque transmitted is individual for different types of clutch discs. In most cases it is possible to provide an elastic rotation angle of at least ±8° at a maximum driving torque transmitted. The fact that the hub has a well-defined rigidity as a function of the rotation angle results here again in the possibility of determining the value of the driving torque transmitted. The clutch disc may thus be used as a torque sensor.

According to another embodiment of the present invention, the first sensor is adapted to detect a first parameter which is related to the rotational position of a flywheel. The flywheel, which is firmly connected to the engine's output shaft, is a suitable component of the first portion of the driveline for detecting such a first parameter value. The parameter may be substantially any desired measurable magnitude which enables determination of the rotational position of the flywheel. With advantage, the first sensor is an existing sensor for detecting the engine's speed. In many cases a sensor which detects the position of the flywheel is used for determining the engine speed. In such cases the rotational position of the flywheel can be determined with an accuracy of ±0.1°. Such a sensor results in accuracy of measurement which is clearly also acceptable for the purposes of the invention. Using such an already existing sensor means that there is no need for any extra sensor to be applied in the vehicle. The second sensor may be adapted to detect a second parameter which is related to the rotational position of the gearbox output shaft. Alternatively, the universal shaft or some other suitable component of the second portion of the driveline may be used. With advantage, the second sensor is an existing sensor for detecting the speed of the vehicle. Here again, an already existing sensor may thus be used for determining the rotational position of a second component. However, this second sensor must also have capacity for being able to determine the rotational position of the second component with relatively great accuracy. In cases where an existing sensor is not used, the second sensor may be applied so that it detects the rotational position of the gearbox input shaft. As both the first component and the second component are in this case situated on the same side of the gearbox, the control unit has in this case no need to take into account the gear engaged in the gearbox and to compensate for relative movement between the first and second components.

According to yet another embodiment of the present invention, the control unit is designed to initiate control of the engine's output torque so as to rectify the mutual angle between the first component and the second component. The fuel supply is preferably controlled so as to adjust the engine's output torque. If a positive driving torque is transmitted in the driveline, the fuel supply to the engine is reduced, and if a negative driving torque is transmitted in the driveline, the fuel supply to the engine is increased. With advantage, the control unit receives substantially continuously measured values pertaining to the first and second parameters and can thus relatively quickly initiate control of the fuel supply so that the mutual rotational position of the first and second components is rectified. When such parameter values are received, it is thus possible to ascertain that zero torque prevails in the gearbox. With advantage, the control unit is in this case designed to activate a gearchange mechanism to disengage the engaged gear when the mutual angle between the first and second components has been rectified. The control unit can then initiate a preliminary activation of the gearchange mechanism already before there is zero torque, so that the gearchange mechanism can substantially immediately disengage the gear when zero torque occurs. Such disengagement results in a very rapid gearchange process.

### BRIEF DESCRIPTION OF THE DRAWINGS

A preferred embodiment of the invention is described below by way of example with reference to the attached drawings, in which:

FIG. 1 depicts schematically an arrangement according to the present invention,

FIG. 2 depicts a clutch disc with a resilient hub,

FIG. 3 depicts schematically the rotational angle between the hub and peripheral portion of the clutch disc as a function of the driving torque transmitted, and

FIG. 4 depicts a flowchart for a method according to the present invention.

### DETAILED DESCRIPTION OF PREFERRED EMBODIMENTS OF THE INVENTION

FIG. 1 schematically depicts selected parts of a motor vehicle. The motor vehicle is driven by an engine 1 which may for example be a diesel engine. The drive motions of the engine 1 are transmitted via a driveline to the vehicle's powered wheels 2. The driveline incorporates an output shaft 3 from the engine 1, a flywheel 4, a clutch 5, an input shaft 6 to a stepped gearbox 7, an output shaft 8 from the gearbox 7, a universal shaft 9, a final gear 10 and driveshafts 1 1 which are connected to the vehicle's powered wheels 2. The driveline comprises a first portion 34 situated before the clutch 5 and a second portion 6-11 situated after the clutch 5. In this embodiment, the clutch 5 is in principle intended to be operated only at the setting in motion and bringing to a halt of the vehicle. The clutch 5 is thus not intended to be operated when the vehicle changes gear while in motion. Gear changing thus takes place with the clutch 5 acting as a connection transmitting driving power between the first portion 3-4 of the driveline and the second portion 6-11 of the driveline.

The vehicle's gearchange system incorporates an electrical control unit 12 designed to receive information from a driver, via a gear lever 13, when a gear change of the vehicle is desired. The control unit 12 is intended, at the time of disengaging a gear, to activate a fuel injection unit 14 in order to control the torque of the engine 1 so that zero torque is obtained in the gearbox 7. When zero torque prevails in the gearbox 7, the control unit 12 is designed to activate a gearchange mechanism 15 which disengages the currently engaged gear. Thereafter the control unit 12 regulates the fuel injection quantity by means of the fuel injection unit 14 so that the speed of the engine 1 becomes such that the gearchange mechanism 15 can engage a new gear.

An arrangement for allowing disengagement of a gear in the gearbox 7 without operating the clutch 5 incorporates a first sensor 16 designed to detect the rotational position P₁ of the flywheel 4, and a second sensor 17 designed to detect the rotational position P₂ of the gearbox output shaft 8. The first sensor 16 is with advantage an already existing sensor which also has the task of detecting the speed of the engine 1. The arrangement also incorporates said control unit 12 which is designed to substantially continuously receive measured values pertaining to the rotational position P₁ of the flywheel 4 and the rotational position P₂ of the gearbox output shaft 8. Conventional devices for measuring the engine speed can determine the rotational position of the flywheel 4 with an accuracy of ±0.1°. With advantage, the control unit 12 calculates with corresponding accuracy the rotational positions P₁, P₂ of the flywheel 4 and the gearbox output shaft 8 respectively.

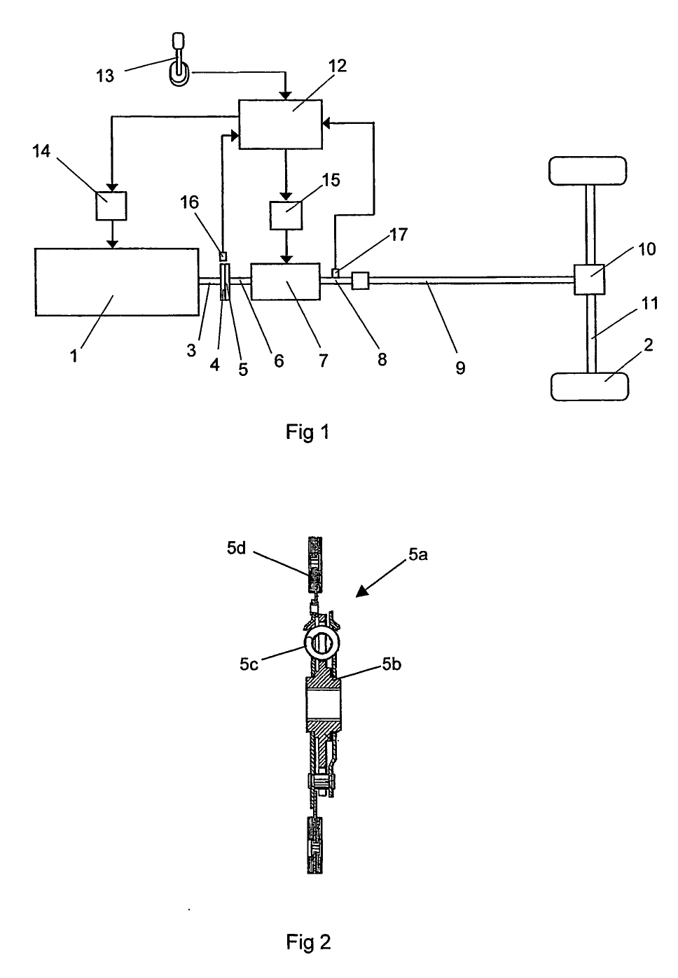

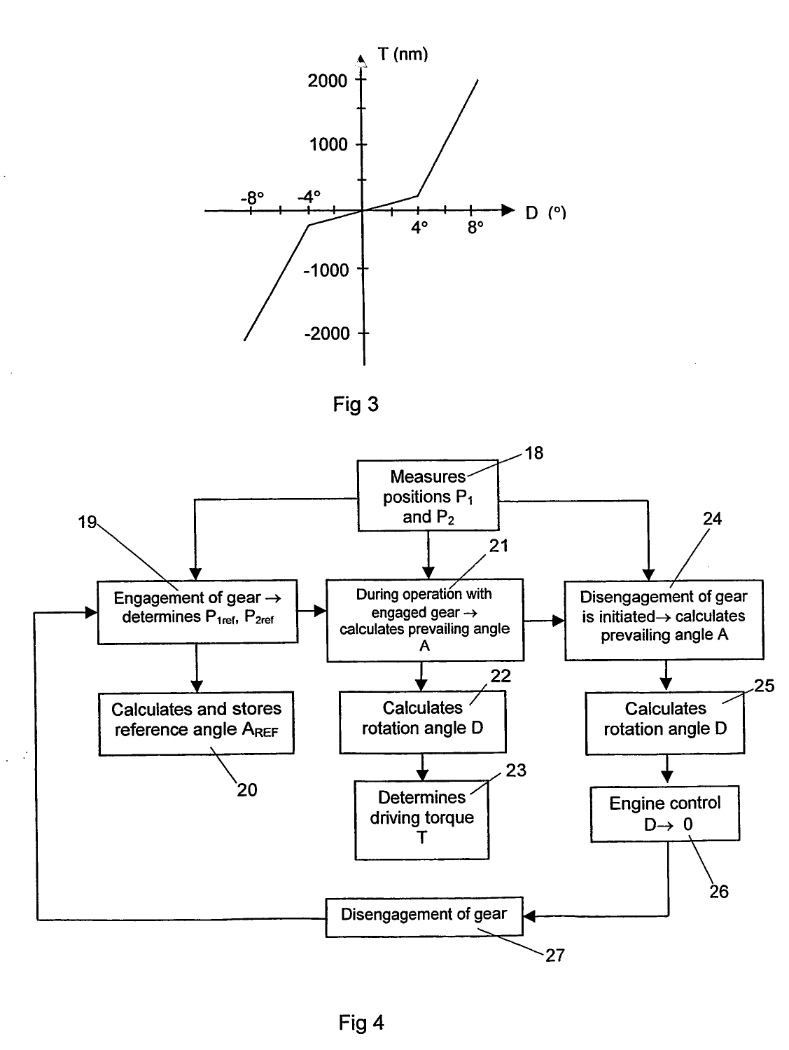

FIG. 2 depicts a clutch disc 5a with hub 5b which is designed to be fastened to the gearbox input shaft 6. A multiplicity of springs 5c, one of which may be seen in FIG. 2, allow resilient elastic rotation of the hub 5b relative to a peripheral portion 5d of the clutch disc 5a. The peripheral portion 5d incorporates friction plates designed to be pressed against the flywheel 4 when the clutch 5 is in a connected state. The relative rotation between the hub 5b and the peripheral portion 5d depends on the magnitude of the driving torque transmitted T. A rotational angle D of at least ±8° is possible for many conventional clutch discs 5a. FIG. 3 shows basically how the rotation angle D may vary with the magnitude of the drive torque transmitted T. The springs 5c of the clutch disc 5a here provide a spring characteristic which allows a substantially linear relationship between the rotation angle D and the drive torque transmitted T when the rotation angle D is within ±4°. Within that angle range the springs 5c give rise to a spring constant which provides relatively gentle resilience. Within the rotation angle range of ±4° there is therefore a relatively large angular deflection D even when the driving torque T is low. When the rotation angle D is greater than 4°, however, the springs 5c give rise to a spring constant which provides a significantly harder resilience. Even if the rotation angle D is not always allowed to be controlled so as to become exactly nil, the drive torque transmitted T will be so low as to always allow an engaged gear to be disengaged without comfort disturbance. With such a relationship between the rotation angle D and the drive torque transmitted T, no unreasonably high requirements are set for the accuracy of measurement of the sensors 16, 17.

When a new gear is engaged in the gearbox 7, zero torque thus prevails in the gearbox 7. To this end, the control unit 12 is designed to store the parameter values P₁ and P₂ received pertaining to the rotational positions of the flywheel 4 and the gearbox output shaft 8 respectively in the form of reference values P_{1,REF} and P_{2,REF}. Thereafter the mutual angle A_{,REF} between the flywheel 4 and the gearbox output shaft 8 can be calculated and stored when zero torque prevails in the gearbox 7. During the vehicle's operation thereafter, with gear engaged, the control unit 12 receives substantially continuously the parameter values P₁ and P₂ pertaining to the prevailing rotational positions of the flywheel 4 and the gearbox output shaft 8. The control unit 12 uses information about the parameter values Pi and P₂ to calculate the prevailing angle A between the flywheel 4 and the gearbox output shaft 8 as the difference between P₁ and P₂. The control unit thereby takes into account the difference in rotation speed between the flywheel 4 and the gearbox output shaft 8 resulting from the gear engaged in the gearbox 7. The control unit 12 calculates thereafter the rotation angle D as the difference between A and A_{,REF}. The fact that a clutch disc hub 5b usually has a well-defined rigidity as a function of the rotation angle D (see FIG. 3) here again results in the possibility of determining the value of the driving torque transmitted T. The clutch disc 5a thus here again acts as a torque sensor.

When a driver initiates engagement of a new gear, via the gear lever 13, the prevailing rotation angle D is calculated in the manner described above. The control unit 12 uses knowledge of the prevailing rotation angle D to initiate appropriate control of the fuel supply to the fuel injection unit 14. The fuel quantity supplied is regulated so that the rotation angle D tends rapidly towards 0, i.e. the prevailing mutual angle A is altered towards the stored mutual angle A_{,REF} when 0 torque prevails in the gearbox 7. When D is assessed to be 0, substantially zero torque prevails in the gearbox 7 and the control unit 12 activates the gearchange mechanism 15, which disengages the currently engaged gear. Thereafter the control unit 12 regulates the fuel injection quantity by means of the fuel injection unit 14 so that the speed of the engine 1 becomes such that the gearchange mechanism 15 can engage the new gear.

FIG. 4 depicts a flowchart pertaining to a method for controlling gear changing of the gearbox 7. At 18, during operation of the vehicle, there is substantially continuous measurement of the value P₁ of the first parameter, which is related to the rotational position of the flywheel 4, and the value P₂ of the second parameter, which is related to the rotational position of the gearbox output shaft 8. At 19, engagement of a gear in the gearbox 7 takes place. At the time of engagement of the gear, information pertaining to the value P₁ of the first parameter when the gear was engaged is stored. This parameter value is stored in the form of a reference value P_{1,REF}. In a corresponding manner, information pertaining to the value P₂ of the second parameter is stored in the form of a reference value P_{2,REF} when the gear was engaged. At 20, knowledge of P_{1,REF} and P_{2,REF} is used to determine the mutual angle A_{REF} between the flywheel 4 and the gearbox output shaft 8. At the mutual angle A_{REF}, zero torque thus prevails in the gearbox 7.

At 21, during operation of the vehicle with the engaged gear, the prevailing mutual angle A between the flywheel 4 and the gearbox output shaft 8 is calculated on the basis of information about the parameter values P₁ and P₂ received. At 22, the rotation angle D is determined as the difference between the prevailing mutual angle A and the stored mutual angle A_{REF}. At this stage, the control unit 12 takes into account the gear engaged in the gearbox in order to determine the difference between the prevailing angle A and the stored angle value A_{REF}. At 23, the value of the driving torque transmitted T, which thus has a well-defined rigidity as a function of the rotation angle D, is determined. The value of the driving torque T is determined, for example, on the basis of values from a curve depicted in FIG. 3.

At 24, the driver uses the gear lever 13 to initiate the engagement of a new gear. At 25, the prevailing rotation angle D is calculated in the manner described above. At 26, the fuel quantity supplied is regulated so that the rotation angle D tends towards 0, i.e. the difference between the prevailing mutual angle A between the flywheel 4 and the gearbox output shaft 8 is altered towards the stored mutual angle A_{,REF}. With conventional technology the rotation angle D can be determined with an accuracy of ±0.1°. When the rotation angle D is deemed to be 0°, substantially zero torque prevails in the gearbox 7. At 27, the rotation angle D is estimated to be 0 and the gear currently engaged is disengaged. Thereafter the fuel injection quantity is regulated so that the speed of the engine 1 is such that a new gear can be engaged in the gearbox 7, which takes place at 19. Thereafter the method is repeated for the engaged gear with new reference values P_{1,REF} and P_{2,REF}, and a new mutual angle A_{REF} between the flywheel 4 and the gearbox output shaft 6 is determined.

The invention is in no way limited to the embodiment described but may be varied freely within the scopes of the claims. If sensors 16, 17 which can determine the positions of the components in the driveline with very great accuracy are used, other components of the driveline than the clutch disc 5a may also be used, since all the components allow more or less elastic rotation when driving torque is being transmitted.

1. An arrangement for allowing disengagement of a gear of a gearbox in a vehicle, wherein the vehicle includes an engine at least one powered wheel, a gearbox, and a driveline including a first driveline portion which extends from the engine, a second driveline portion which extends to the at least one powered wheel of the vehicle and a specific element of the driveline between the first and the second portions,
the element being adapted to allow elastic rotation between the first and the second driveline portions when driving torque is being transmitted in the driveline;
a first sensor operable to detect the position (P₁) of the first portion of the driveline, and a second sensor operable to detect the position (P₂) of the second portion of the driveline,
a control unit operable to store at least one measured value which is related to a mutual angle (A_{REF}) between the position (P_{1,REF}) of the first portion and the position (P_{2,REF}) of the second portion when a gear is engaged in the gearbox, and is operable to initiate a control action so that the mutual angle (A_{REF}) between the first portion and the second portion is rectified before the gear is disengaged.

2. An arrangement according to claim 1, further comprising a clutch in the driveline, and the specific element is incorporated in the clutch.

3. An arrangement according to claim 2, wherein the specific element comprises a clutch disc of the clutch, the clutch disc includes a hub connected to one of the first and second portions of the driveline and a peripheral portion of the disc around the hub, the clutch disc being operable to allow elastic rotation between the hub and the peripheral portion of the clutch disc.

4. An arrangement according to claim 1, wherein the specific element allows elastic rotation of at least ±8°.

5. An arrangement according to claim 1, further comprising a flywheel on the first portion of the driveline and rotatable therewith; the first sensor is operable to detect a first parameter which is related to the rotational position of the flywheel.

6. An arrangement according to claim 1, wherein the first sensor is operable to detect the speed of the engine.

7. An arrangement according claim 1, further comprising an output shaft from the gearbox, the output shaft being in the second portion of the driveline, and the second sensor is operable to detect a second parameter which is related to the rotational position of the output shaft of the gearbox.

8. An arrangement according to claim 1, wherein the second sensor is operable to detect the speed of the vehicle.

9. An arrangement according to claim 1, wherein the control unit is operable to initiate control of the output torque of the engine rectifying the mutual angle (A_{REF}) between the first and the second driveline portions before a gear is disengaged at the gearbox.

10. An arrangement according to claim 1, further comprising a gearchange mechanism in the gearbox; the control unit is operable to activate the gearchange mechanism for disengaging the engaged gear when the mutual angle (A_{REF}) between the first and the second portions has been rectified.

11. A method for allowing disengagement of a gear in a gearbox of a vehicle, wherein the vehicle includes an engine, a gearbox, a driveline having a first portion which extends from the engine to a specific element of the driveline, and a second portion which extends from the element to at least one powered wheel of the vehicle, and the specific element is adapted to allow elastic rotation between the first and the second portions of the driveline when driving torque is being transmitted in the driveline, the method comprising:
detecting a position (P₁) of the first portion of the driveline, and detecting a position (P₂) of the second portion of the driveline;
storing at least one measured value which is related to a mutual angle (A_{REF}) between the position (P_{1,REF}) of the first driveline portion and the position (P_{2,REF}) of the second driveline portion when a gear is engaged in the gearbox, and for initiating a control action so that the mutual angle (A_{REF}) between the first and the second driveline portions is rectified before the gear is disengaged.

12. A method according to claim 11, wherein the first portion of the driveline has a flywheel, and the method further comprises detecting a first parameter of the first portion (P₁) which is related to the rotational position of the flywheel.

13. A method according to claim 11 wherein the gearbox has an output shaft in the second portion of the driveline, and the method further comprises detecting a second parameter of the second position (P₂) which is related to the rotational position of the output shaft of the gearbox.

14. A method according to claim 11, further comprising controlling the output torque of the engine for rectifying a mutual angle (A_{REF}) between the first and the second driveline portions before the gear is disengaged.

15. A method according to claim 11, further comprising activating a gearchange mechanism for disengaging the engaged gear when the mutual angle (A_{REF}) between the first and the second driveline portions has been rectified.

16. An arrangement according to claim 1, further comprising a first component of the first portion of the driveline, and the first sensor is operable to detect the first component; and a second component of the second portion of the driveline and the second sensor is operable to detect the second component.

17. An arrangement according to claim 9, further comprising a gearchange mechanism in the gearbox; the control unit is operable to activate the gearchange mechanism for disengaging the engaged gear when the mutual angle (A_{REF}) between the first and the second portions has been rectified.

18. A method according to claim 11, wherein the first portion of the driveline has a first component and the second portion of the driveline has a second component;
the method further comprising
detecting the position of the first portion of the driveline comprises detecting the position of the first component, and detecting the position of the second portion of the driveline comprises detecting the position of the second component.

19. A method according to claim 12, wherein the gearbox has an output shaft in the second portion of the driveline, and the method further comprises detecting a second parameter of the second portion (P₂) which is related to the rotational position of the output shaft of the gearbox.

20. A method according to claim 14, further comprising activating a gearchange mechanism for disengaging the engaged gear when the mutual angle (A_{REF}) between the first and the second driveline portions has been rectified.
